(19) United States
(12) Patent Application Publication
(10) Pub. No.: US 2006/0212521 A1
(43) Pub. Date: Sep. 21, 2006

(54) Asynchronous transactions action buttons over communication mediums

(76) Inventors: Nadeem Malik, Austin, TX (US); Avijit Saha, Somers, NY (US)

Correspondence Address: JANIS E. CLEMENTS, 3112 LOMITA DRIVE, AUSTIN, TX, 78738, US

(21) Appl. No.: 11/082,703

(22) Filed: Mar. 17, 2005

(51) Int. Cl. G06F 15/16

(52) U.S. Cl. 709/206

(57) ABSTRACT

A system, method, and related computer program for asynchronous transactions action buttons over communication mediums. The present invention allows users to maintain control over an instant message after it is sent. More specifically, a sender of an instant message can revoke a sent instant message, or amend a sent instant message. Further, a receiver of an instant message can respond directly to the instant message and also enjoys the continued control over the sent response instant message. In the present invention, display devices used for sending and receiving said instant messages include cellular telephones, PDAs, and laptop computers.

### TECHNICAL FIELD

The present invention relates to computer managed communication networks such as the World Wide Web (Web) or like private intranet networks that distribute electronic messages transmitted to users who may log on at a variety of display terminals or stations, and particularly to instant messaging systems using such networks.

### BACKGROUND OF RELATED ART

The past decade has been marked by a technological revolution driven by the convergence of the data processing industry with the consumer electronics industry. The effect has, in turn, driven technologies that have been known and available but relatively quiescent over the years. A major one of these technologies is the Internet (or Web) related distribution of documents. The Internet (or Web), which had quietly existed for over a generation as a loose academic and government data distribution facility, reached “critical mass” and commenced a period of phenomenal expansion. With this expansion, businesses and consumers have direct access to all matter of documents and media through the Web.

The availability of extensive distribution channels has made it possible to keep all necessary parties in business, government, and public organizations completely informed of all transactions that they need to know about at almost nominal costs through conventional electronic mail.

Among the many and varied industry efforts to focus the user's attention on the mail and mail sources most significant to a user from among the many available to him has been instant messaging. In an instant messaging system, a user may log in at any individual display terminal on a network and join a select group of other users logged in at other like display terminals to form a set of users at terminals that are, in effect, interconnected at server levels in networks for communications. International Business Machines Corporation's Lotus Sametime product line is an example of such an instant messaging system. The selected set of participants in any instant messaging network are people with special common, but often limited, interests, e.g. a set of close friends, a family, business partners, a business team, a group of sports or game players, an education study group. The purpose of such an instant messaging team or group is real-time textual conversations within the group. The instant messaging transaction is alive until synchronous connection is made, and a sender has no control over a sent instant message once the transfer of the instant message file is complete.

### SUMMARY OF THE PRESENT INVENTION

The present invention provides a solution to the previously recited problems by a system, method, and related computer program for asynchronous transactions action buttons over communication mediums regarding instant messaging. The invention is operable in an instant messaging communication network environment with user access via a plurality of data processor controlled interactive receiving display stations operated by a plurality of users to send and receive displayable messages. The system comprises interactive browser means associated with each of the said receiving stations for responding to received instant messages from the network and displaying the documents at any receiving display station. This system further comprises means for a sender to maintain control over a sent instant message file by encapsulating said file as an object with an agent code. The agent code maintains an agent link between a sender and a receiver over a distributed system.

### BRIEF DESCRIPTION OF THE DRAWINGS

The present invention will be better understood and its numerous objects and advantages will become more apparent to those skilled in the art by reference to the following drawings, in conjunction with the accompanying specification, in which:

FIG. 1 is a block diagram of a data processing system including a central processing unit and network connections via a communications adapter which is capable of implementing the interactive display terminals, as well as servers in the instant messaging network of this invention;

FIG. 2 is a generalized view of a Web or Internet network that may be used for instant messaging distribution in the practice of the present invention;

FIG. 3 shows an object and instant message received at a user's terminal display from a sender of the instant message of the present invention;

FIG. 4 is an illustrative flowchart describing the setting up of the functions of the present invention for asynchronous instant messaging transactions action buttons over communication mediums; and

FIG. 5 is a flowchart of an illustrative run of the program set up in FIG. 4.

### DETAILED DESCRIPTION OF THE PREFERRED EMBODIMENT

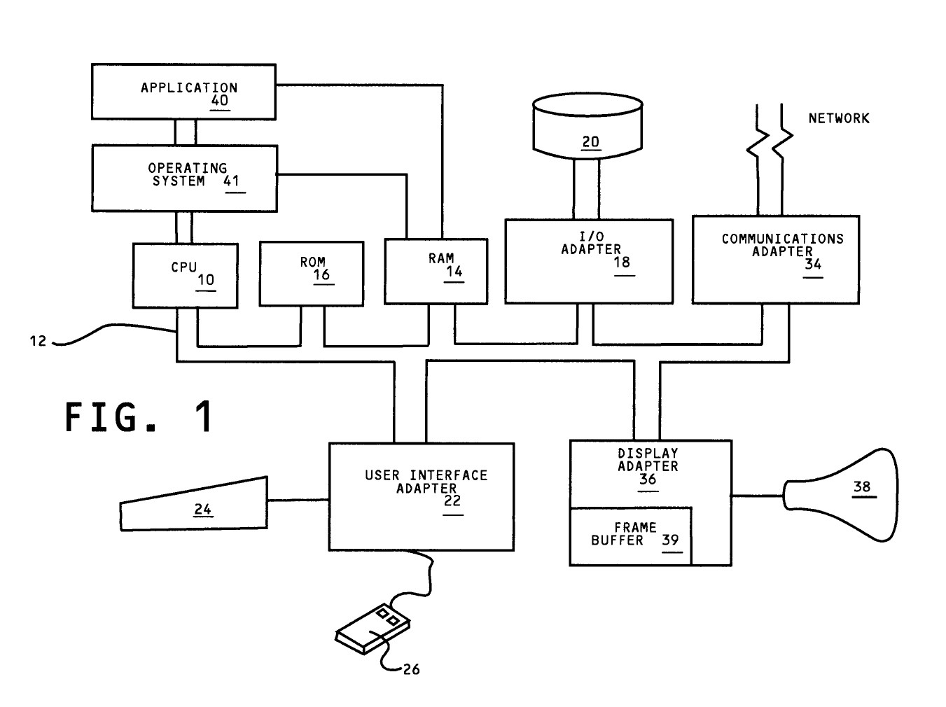

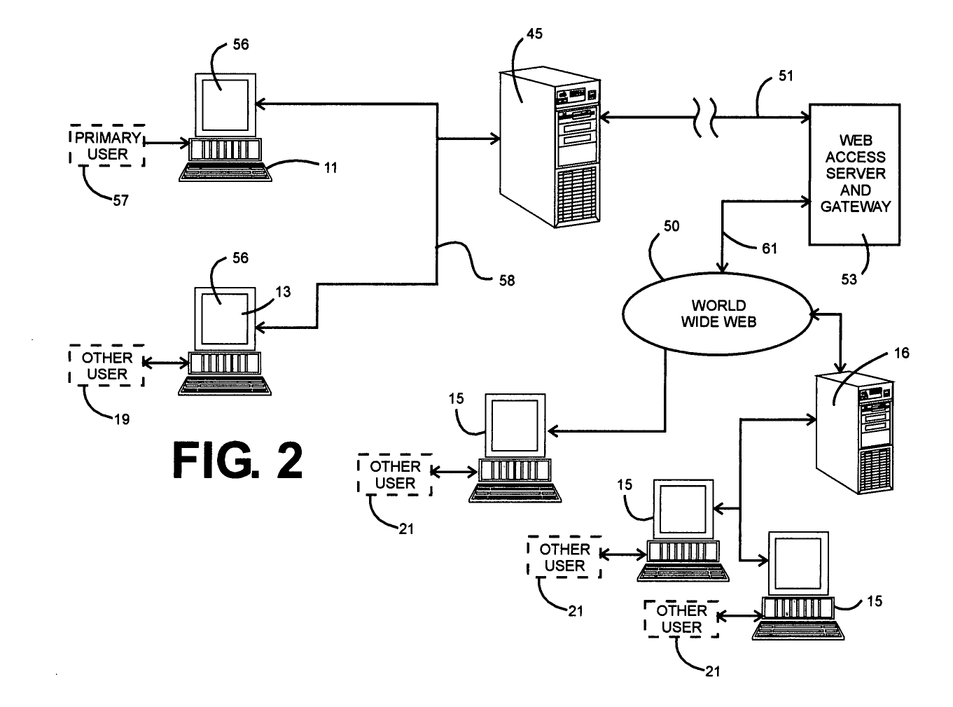

Referring to FIG. 1, a typical data processing system is shown that may function as the computer controlled network terminals or Web terminals or stations used conventionally as any of the sending or receiving stations for instant messaging transmissions. The system shown is also illustrative of any of the server computers used for the instant message distribution to be described in greater detail with respect to FIG. 2.

A central processing unit (CPU) 10 may be one of the commercial microprocessors in personal computers available from International Business Machines Corporation (IBM) or Dell Corporation; when the system shown is used as a server computer at the Web distribution site to be subsequently described, then a workstation is preferably used (e.g., RISC System/6000™ (RS/6000) series available from IBM). The CPU 10 is interconnected to various other components by system bus 12. An operating system 41 runs on a CPU 10, provides control, and is used to coordinate the functions of the various components of FIG. 1. Operating system 41 may be one of the commercially available operating systems such as AIX 6000™ operating system available from IBM; Microsoft's Windows XP™; or Windows2000™, as well as other UNIX and IBM AIX operating systems. Application programs 40, controlled by the system, are moved into and out of the main memory Random Access Memory (RAM) 14. These programs include the programs of the present invention for asynchronous instant messaging transactions action buttons over communication mediums. A Read Only Memory (ROM) 16 is connected to CPU 10 via bus 12 and includes the Basic Input/Output System (BIOS) that controls the basic computer functions. RAM 14, I/O adapter 18 and communications adapter 34 are also interconnected to system bus 12. I/O adapter 18 communicates with the disk storage device 20. Communications adapter 34 interconnects bus 12 with the outside network enabling the computer system to communicate with other such systems over the Web or Internet. The latter two terms are meant to be generally interchangeable and are so used in the present description of the distribution network. I/O devices are also connected to system bus 12 via user interface adapter 22 and display adapter 36. Keyboard 24 and mouse 26 are all interconnected to bus 12 through user interface adapter 22. It is through such input devices that the user at a receiving station may interactively relate to the network in order to access instant messages. Display adapter 36 includes a frame buffer 39, which is a storage device that holds a representation of each pixel on the display screen 38. Images may be stored in frame buffer 39 for display on monitor 38 through various components, such as a digital to analog converter (not shown) and the like. By using the aforementioned I/O devices, a user is capable of inputting information to the system through the keyboard 24 or mouse 26 and receiving output information from the system via display 38.

Before going further into the details of specific embodiments, it will be helpful to understand from a more general perspective the various elements and methods that may be related to the present invention. Because a major aspect of the present invention is directed to instant messaging documents transmitted over networks, an understanding of networks and their operating principles would be helpful. We will not go into great detail in describing the networks to which the present invention is applicable. Reference has also been made to the applicability of the present invention to a network, such as the Internet or Web. For details on Internet nodes, objects and links, reference is made to the text, Mastering the Internet, G. H. Cady et al., published by Sybex Inc., Alameda, Calif., 1996.

The Internet or Web is a global network of a heterogeneous mix of computer technologies and operating systems. Higher level objects are linked to the lower level objects in the hierarchy through a variety of network server computers. Instant messaging, as will be described with respect to FIG. 2, may be distributed through a local network, e.g. an intranet, or through the Internet.

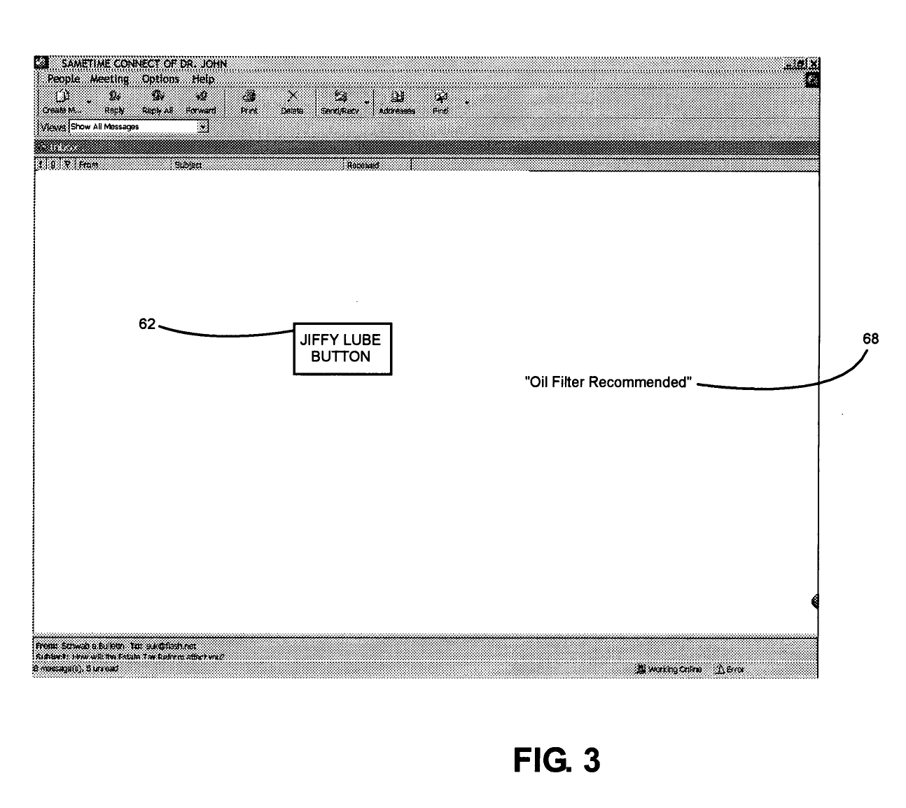

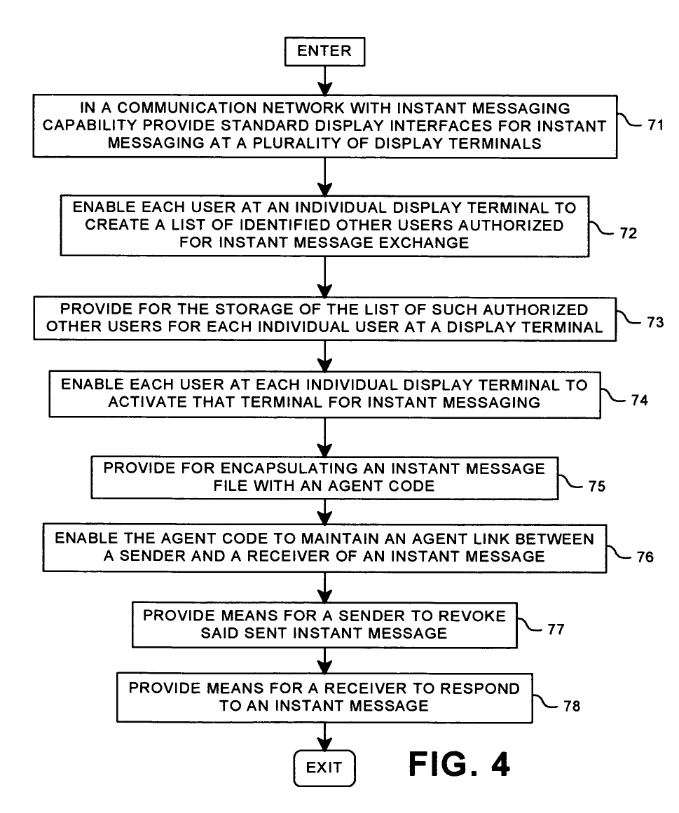

A generalized diagram of both an intranet portion and a Web or Internet portion is shown to illustrate the instant mail distribution system of the present invention in FIG. 2. An instant messaging user group that will subsequently be used in connection with FIGS. 3 and 4, is an intranet group with primary user 57 (for purposes of illustration) operating display 56 or terminal 11 connected for instant messaging through server 45 with other users 19 respectively connected through other user controlled stations 13 to server 45 in a conventional instant messaging arrangement. The instant messaging group may be more global wherein server 45 is connected through a Web/Internet access server 53 and an appropriate gateway, connector 61 via the Web 50 to another instant messaging through server 11. In this manner, the illustrative display of FIGS. 3 and 4 covers a primary user 57 connected in an intranet to other users 19 and via the Web to other users 21 through the display interfaces to be described. Reference may be made to the above-mentioned Mastering the Internet, pp. 136-147, for typical connections between local display stations to the Web via network servers, any of which may be used to implement the system on which this invention is used.

Within this network set up, we will now consider the illustrative instant messaging with asynchronous transactions action buttons over a communication medium to be described with respect to FIG. 3, which is a display panel for instant messaging receiving/sending of Dr. John 19, a customer at Jiffy Lube™. In FIG. 3 there is illustrated a diagram of one example of the present invention wherein a primary user 57, a Jiffy Lube™ employee, notifies another user 19, a customer (Dr. John), regarding maintenance on his vehicle via instant messaging over Dr. John's cellular telephone 60. When Dr. John 19 first entered the store's premises and communicated with the employee 57, this communication was in person. In this example, Dr. John 19 explained to the employee 57 that he wanted an oil change for his vehicle. The employee 57 then sent a service icon object 62 to Dr. John's 19 cellular telephone 60. In the present invention, the employee 57 has means for storing a list of a plurality of identified users 19 authorized for instant message exchange through user display stations operated by said users 19, such as cellular telephones 60, PDAs, or laptop computers. The sender/employee 57 maintains control over a sent instant message file by encapsulating said file as an object with an agent code. The agent code maintains an agent link between a sender and a receiver over a distributed system. The sender/employee 57 can even revoke said sent instant message file. A receiver, Dr. John 19, can respond to the instant message. In the current example, while the oil service was being performed, the employee 57 was able to send Dr. John 19 an inquiry 68 via the icon object 62 to inform Dr. John 19 of the status of his service and to request permission to change the oil filter. Dr. John 19 could give his authorization of the oil filter change with the service button/icon object 62. Dr. John 19 could also request to speak directly to an employee 57 by activating the icon object 62. Once Dr. John 19 has completed his business with Jiffy Lube™, the employee 57 can cancel the service button/icon object 62. Dr. John 19 can respond to messages 68 sent by the employee regarding the servicing of his vehicle or he can request to speak to the employee.

FIG. 4 is a flowchart showing the development of a process according to the present invention for asynchronous transactions action buttons over communication mediums. In any standard instant messaging network system, enabling group members operating display terminals to distribute instant messaging to specified recipients, there is provision made for a conventional instant messaging group via a plurality of display terminal interfaces respectively operated by each member of the instant messaging group, step 71. Each individual group member is enabled to create at his terminal display interface, a list of other identified display member terminals authorized for this groups' instant messaging exchange, step 72. Provision is made for the storage of this respective list of such authorized group members at a server available to each individual member display terminal, step 73. Each group member or user at each individual display terminal is enabled to activate that terminal for instant messaging, step 74. Provision is made for encapsulating an instant message file with an agent code, step 75. The agent code maintains an agent link between a sender and a receiver of an instant message over a distributed system, step 76. A sender can revoke said sent instant message, step 77. A receiver can respond to an instant message, step 78.

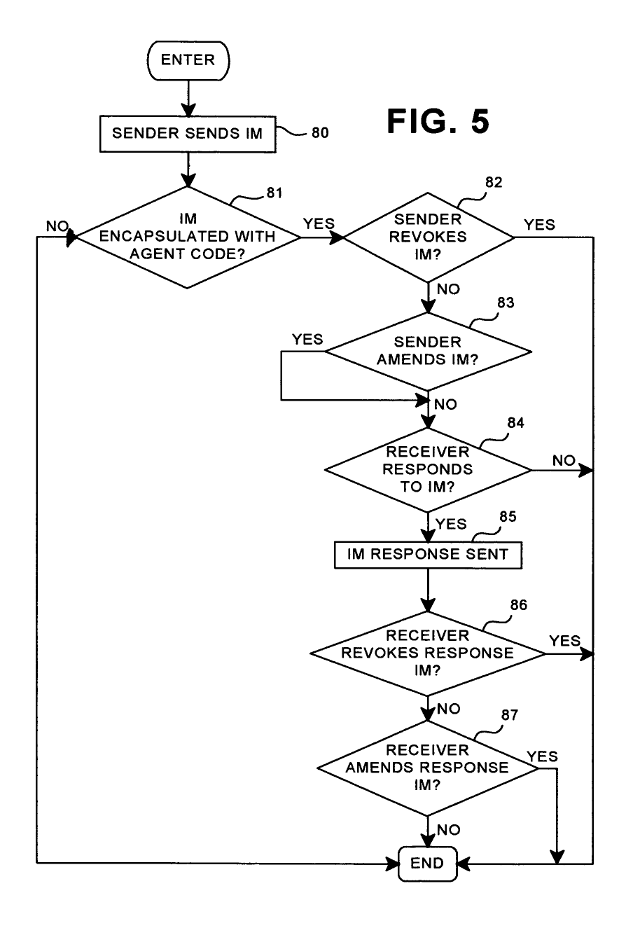

The running of the process set up in FIG. 4 and described in connection with FIG. 3 will now be described with respect to the flowchart of FIG. 5. The flowchart represents some steps in a routine that will illustrate the operation of this invention. At the display terminal of the instant messaging user there is provided an interface such as that of FIG. 3. Let us assume that in the system to be described, that a group of members is set up for instant messaging. First, a sender of an instant message sends an instant message. Step 80, and a determination is made as to whether the instant message is encapsulated with an agent code, step 81. If No, the process ends. Said agent code maintains an agent link between sender and receiver over a distributed system. If Yes, then during the life of the instant message file after the instant message is sent, a sender can revoke the instant message, step 82, and the process ends. If the sender does not revoke the instant message, the sender can amend the instant message during the life of the instant message file, step 83, and the message remains a “sent” message, so the process continues regardless of whether the sender amends the instant message. A determination is made by the receiver of the instant message, step 84, as to whether, at the individual display terminal operated by the receiver, to respond to the instant message. Said display devices include cellular telephone, PDAs, and laptop computers. If No, the process ends. If Yes, the receiver's instant message reply is sent to the sender, step 85. The receiver maintains control over the reply message in the same manner described herein as related to the original sender of the instant message, and can revoke the response, step 86, which will end the process. If the receiver does not revoke the instant message response, the receiver can opt to amend the response, step 87.

One of the preferred implementations of the present invention is in application program 40 made up of programming steps or instructions resident in RAM 14, FIG. 1, of Web server computers during various Web operations. Until required by the computer system, the program instructions may be stored in another readable medium, e.g., in disk drive 20, or in a removable memory, such as an optical disk for use in a CD ROM computer input or in a floppy disk for use in a floppy disk drive computer input. Further, the program instructions may be stored in the memory of another computer prior to use in the system of the present invention and transmitted over a Local Area Network (LAN) or a Wide Area Network (WAN), such as the Internet, when required by the user of the present invention. One skilled in the art should appreciate that the processes controlling the present invention are capable of being distributed in the form of computer readable media of a variety of forms.

Although certain preferred embodiments have been shown and described, it will be understood that many changes and modifications may be made therein without departing from the scope and intent of the appended claims.

What is claimed is:

1. In an instant messaging communication network including a plurality of display devices for displaying Web documents transmitted to receiving display stations operated by a plurality of users to send and receive displayable messages, a system for asynchronous transactions action buttons over communication mediums comprising:
storage device including a list of a plurality of identified users authorized for instant message exchange through user display stations operated by said users;
a processor that enables instant message exchange at each identified user operated station; and
agent code that encapsulates said file for a sender to maintain control over a sent instant message file.

2. The instant messaging network system of claim 1 wherein said agent code maintains an agent link between a sender and a receiver over a distributed system.

3. The instant messaging network system of claim 2 wherein said sender can revoke said sent instant message file.

4. The instant messaging network system of claim 3 wherein said receiver can respond to an instant message.

5. The instant messaging network system of claim 4 wherein said display devices include cellular telephones.

6. The instant messaging network system of claim 4 wherein said display devices include PDAs.

7. The instant messaging network system of claim 4 wherein said display devices include laptop computers.

8. In an instant messaging communication network including a plurality of display devices for displaying Web documents transmitted to receiving display stations operated by a plurality of users to send and receive displayable messages, a method for asynchronous transactions action buttons over communication mediums comprising:
storing a list of a plurality of identified users authorized for instant message exchange through user display stations operated by said users;
enabling an identified user operating a display station to activate said identified user station for instant message exchange; and
encapsulating a sent instant message file with an agent code for a sender to maintain control said instant message file.

9. The instant messaging method of claim 1 wherein said agent code maintains an agent link between a sender and a receiver over a distributed system.

10. The instant messaging method of claim 2 wherein said sender can revoke said sent instant message file.

11. The instant messaging method of claim 3 wherein said receiver can respond to an instant message.

12. The instant messaging method of claim 4 wherein said display devices include cellular telephones.

13. The instant messaging method of claim 4 wherein said display devices include PDAs.

14. The instant messaging method of claim 4 wherein said display devices include laptop computers.

15. A network browser computer program having code recorded on a computer readable medium associated with each of said receiving stations for eliminating extraneous displayable data from received documents in a communication network with user access via a plurality of data processor controlled interactive receiving display stations for asynchronous transactions action buttons over communication mediums comprising:
means for storing a list of a plurality of identified users authorized for instant message exchange through user display stations operated by said users;
means at each identified user operated station enabling said user to activate said identified user station for instant message exchange; and
means for a sender to maintain control over a sent instant message file by encapsulating said file with an agent code.

16. The computer program of claim 1 wherein said agent code maintains an agent link between a sender and a receiver over a distributed system.

17. The computer program of claim 2 wherein said sender can revoke said sent instant message file.

18. The computer program of claim 3 wherein said receiver can respond to an instant message.

19. The computer program of claim 4 wherein said display devices include cellular telephones.

20. The computer program of claim 4 wherein said display devices include laptop computers.
